(19) United States
(12) Patent Application Publication
(10) Pub. No.: US 2017/0228698 A1
(43) Pub. Date: Aug. 10, 2017

(54) SYSTEM AND METHOD FOR BENEFIT DISTRIBUTION WITH IMPROVED PROOF-OF-LIFE FEATURES

(71) Applicant: MasterCard International Incorporated, Purchase, NY (US)

(72) Inventor: Manoneet Kohli, O'Fallon, MO (US)

(21) Appl. No.: 15/040,495

(22) Filed: Feb. 10, 2016

(51) Int. Cl. G06Q 10/10; G06Q 20/40; G06Q 20/10

(52) U.S. Cl. CPC G06Q 10/1057; G06Q 20/10; G06Q 20/40145

(57) ABSTRACT

A method includes determining that a benefit payment is due to be made to a recipient. A data store is accessed, where the data store contains records of payment transactions made by the recipient. An indication is received from the data store that the recipient had successfully performed a biometric user authentication with respect to at least one of the payment transactions. The indication received from the data store is accepted as proof-of-life with respect to the recipient. The benefit payment is made to the recipient in response to the proof-of-life.

### BACKGROUND

Around the world there are many programs under which individuals receive payments on a regular periodic basis so long as they remain alive. One well-known example is the U.S. Social Security program. In its main aspect, individuals of retirement age and beyond receive monthly benefit payments that cease upon the individual's death. Similar programs, sometimes referred to as “government pension plans” also exist in other countries.

According to other programs, plans or contractual arrangements, individuals may also receive periodic payments for the terms of their lives. Such arrangements may include pension plans sponsored by private employers, pension plans for retired government employees, lifetime annuities purchased by the recipient as a retirement income strategy, and so forth.

According to some programs, the individual is required to provide “proof-of-life” before receiving each periodic benefit payment. This may involve the recipient appearing in person at the disbursing organizations office with credible personal identification documents. However, this type of proof-of-life approach is very inconvenient, time-consuming and expensive.

U.S. published patent application no. 2013/0159194 (which names Tariq Habib as the inventor) proposes a biometric-based proof-of-life system for benefit disbursement, using the recipient's mobile device as a facilitating platform. However, this approach also may entail expense and inconvenience.

Still other benefit payment programs do not require proof-of-life prior to disbursement of each periodic benefit payment. One risk faced by such programs is that they may fail to receive notification that the recipient has died, and thus a fraudulent continuation of payments beyond the recipient's death may occur, resulting in losses to the benefit program.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment account system.

FIG. 2 is a block diagram of a benefit payment system according to some embodiments.

FIGS. 3, 4 and 5 are block diagram representations of computers that may serve as components of the system shown in FIG. 2.

FIG. 6 is a block diagram representation of a mobile device that may serve as a component of the system shown in FIG. 2.

FIGS. 7, 8 and 9 are flow charts that illustrate aspects of the present disclosure.

### DETAILED DESCRIPTION

In general, and for the purpose of introducing concepts of embodiments of the present disclosure, a benefit payment system may avail itself of records maintained or generated by a payment account system to aid in making determinations as to proof-of-life of benefit recipients prior to disbursing periodically due benefit payments to the recipients. The benefit payment system may access records of payment account system transactions made by a benefit recipient to determine whether the recipient has recently successfully engaged in a biometric-based user authentication procedure in connection with one of the recipient's payment account system transactions. If so, the benefit payment system may accept the recent biometric user authentication as a proof-of-life with respect to the recipient for purposes of determining whether to release a currently payable benefit payment to the recipient. In the absence of such a recent payment account transaction with biometric user authentication, the benefit payment system may initiate a biometric-based process to establish proof-of-life for the recipient.

By availing itself of potentially useful and probative payment account system records, as described above, the benefit payment system may make reliable confirmations of recipient proof-of-life, with minimal cost and processing, while avoiding inconvenience to the recipient and minimizing the burdens on a biometric-based proof-of-life system.

In view of the relevance of payment account systems to aspects of the present disclosure, the discussion will now turn to a conventional payment account system, as background to a subsequent description of details of a benefit payment system provided in accordance with teachings of this disclosure.

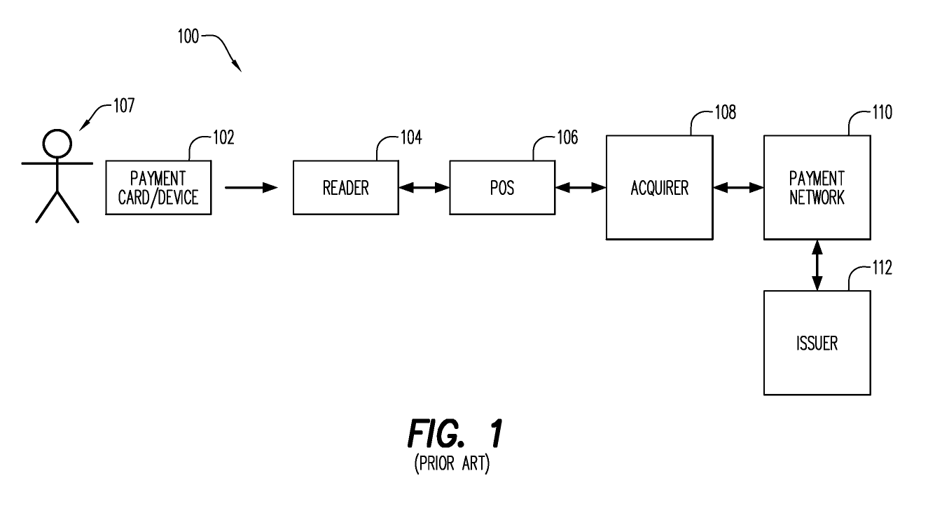

FIG. 1 is a block diagram that illustrates a conventional payment account system 100 that may potentially be a source of transaction records that may be relied upon by a benefit payment system to be described below.

The system 100 includes a conventional payment card/device 102 (which may alternatively be, for example, a payment IC card or a payment-enabled mobile device that stores a payment card account number or payment token and runs a payment app). The system 100 further includes a reader component 104 associated with a POS terminal 106. In some known manner (depending on the type of the payment card/device 102) the reader component 104 is capable of reading the payment card account number/token and other information from the payment card/device 102. In some situations, the payment device 102 is a mobile device that runs an application to allow access to a payment token subject to user authentication by verification of the user's fingerprint via a fingerprint sensor on the mobile device.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction. Reference numeral 107 indicates a user/account holder who is a customer at the retail store and who has presented the payment card/device 102 to the reader component in order to settle the retail transaction.

A computer 108 operated by an acquirer (acquiring financial institution; sometimes referred to as a “transaction acquirer”) is also shown as part of the system 100 in FIG. 1. The acquirer computer 108 may operate in a conventional manner to receive a payment account transaction authorization request message (sometimes referred to as an “authorization request”) for the transaction from the POS terminal 106. The acquirer computer 108 may route the authorization request via a payment network 110 to the server computer 112 operated by the issuer of a payment account that is associated with the payment card/device 102. As is also well known, the payment account transaction authorization response message (also referred to as an “authorization response”) generated by the payment account issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment network 110 may store transaction information contained in the transaction messaging that is routed via the payment network 110.

The payment card issuer server computer 112 may be operated by or on behalf of a financial institution (“FI”) that issues payment accounts to individual users and other entities. For example, the payment account issuer server computer 112 may perform such functions as (a) receiving and responding to requests for authorization of payment account system transactions to be charged to payment accounts issued by the FI; and (b) tracking and storing transactions and maintaining account records.

The components of the system 100 as depicted in FIG. 1 are only those that are needed for processing a single transaction. A typical payment account system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment cards or other devices for initiating payment transactions by presenting an associated payment account number or token to the reader component of a POS terminal.

As is also well known, payment account numbers and/or payment tokens may also be employed in online shopping transactions. In such transactions, the user/customer may interact with a shopping website hosted by the merchant's e-commerce server computer (not shown). For such transactions, the merchant's e-commerce server computer may perform many of the functions ascribed above to the POS terminal 106. Such functions may include initiating a payment transaction authorization request message and receiving back a payment transaction authorization response message. It has been proposed for such transactions that, at least in some cases, the user may be required to successfully respond to a user authentication challenge via his/her smartphone before the online shopping transaction is permitted to go forward. According to some proposals, the user authentication may be biometric, including such biometric measures as fingerprint verification, voice recognition, facial recognition, gait recognition, etc.

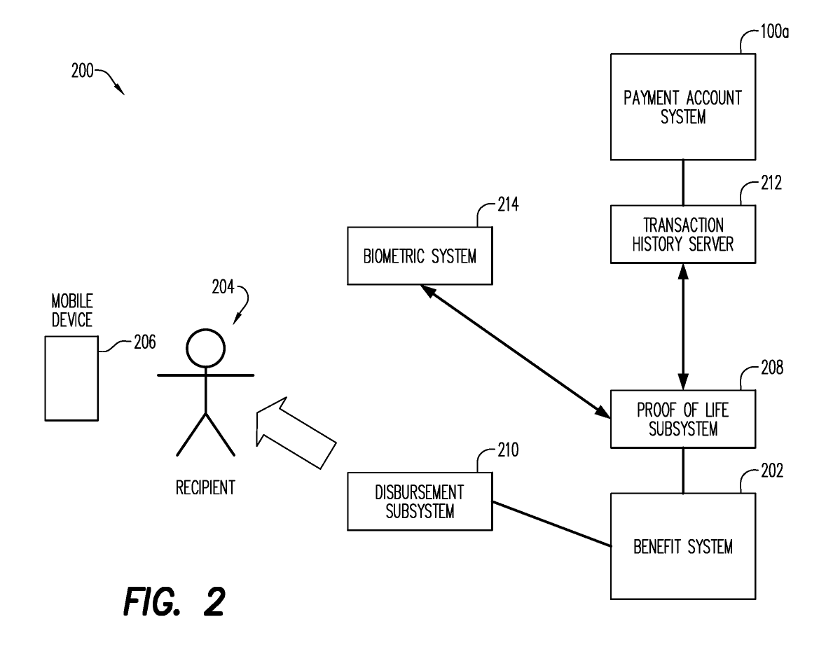

FIG. 2 is a block diagram of a benefit payment system 200 provided according to some embodiments.

The benefit payment system 200 may be provided to disburse any one or more of a variety of benefit payments, including Social Security benefits, government pension benefits, retired employee pension benefits, other types of social insurance transfer payments, and contracted-for periodic payments such as annuity benefits, etc.

A central component of the benefit payment system 200 is a benefit system computer 202. Details of the benefit system computer 202 will be provided below. As will be seen, the benefit system computer 202 may play a key coordinating role in determining when benefit payments are due and whether the payments should be disbursed.

An example beneficiary/recipient (i.e., an individual entitled to receive benefit payments under the benefit payment system 200) is represented at 204 in FIG. 2. Reference numeral 206 indicates a mobile device owned or used by the recipient 204.

Two subsystems—a proof-of-life subsystem 208 and a payment disbursement subsystem 210—are shown as operatively connected to, and controlled by, the benefit system computer 202.

Also included as an adjunct to the benefit payment system 200 is a payment account system 100a. The payment account system 100a may have all of the attributes and functionality of the conventional payment account system 100 described above. However, with respect to conventional payment account system 100, it may not be the case that the system includes transaction data capture and storage capabilities as required to provide assistance to the benefit payment system 200, and particularly the benefit system computer 202, as described herein. Accordingly, for present purposes, it may be assumed that the payment account system 100a has been modified to include transaction data capture and storage as required to support functionality of the benefit payment system 200 as described herein.

Accordingly, the payment account system 100a may include or have as an adjunct element the transaction history server computer indicated by reference numeral 212. The transaction history server computer 212 may be accessed from time to time (perhaps on numerous occasions) by the proof-of-life subsystem 208 mentioned above. The transaction history server computer 212 may function as a repository for transaction history data to support decision-making by the proof-of-life subsystem 208 as to whether proof of life has been established for benefit recipients via their payment account system transactions.

The benefit payment system 200 may further include a biometric system 214. The biometric system 214 may be subject to requests from time to time from the proof-of-life subsystem 208. The biometric system 214 may operate in a similar manner to proposed systems that use biometric measures for user authentication in connection with payment account systems. The biometric system 214 may respond to requests from the proof-of-life subsystem 208 by sending challenges to benefit system recipients to provide satisfactory biometric input by the recipients' mobile devices. When the recipients satisfactorily respond to challenges from the biometric system 214, this may be taken as confirmation of proof-of-life. As will be seen, according to teachings of the present disclosure, the proof-of-life subsystem 208 may request the biometric system 214 to confirm proof-of-life for a recipient only when the proof-of-life subsystem 208 is unable to do so by reference to the payment account system transaction records for the recipient.

In some embodiments, the biometric system 214 may be operated by the operator of a payment network such as the payment network 110 shown in FIG. 1. Such may also be the case for the transaction history server computer 212.

To discuss the subject matter of FIG. 2 more generally, it should be understood that in most cases, blocks labeled therein with names/descriptions of entities should also be understood to represent computer systems operated by or for such entities.

Although only one recipient 204 (and one recipient mobile device 206) is shown explicitly in FIG. 2, in a practical embodiment of the benefit payment system 200 there may be many recipients of benefits under the benefit payment system, and each recipient may have his or her own mobile device.

In some embodiments of the benefit payment system 200, more than one payment account system 100a and/or more than one transaction history server computer 212 may serve as a resource to the benefit system computer 202/proof-of-life subsystem 208 to aid in confirming proof-of-life for benefit recipients from the recipients' payment account transactions. In some embodiments, the transaction history server computer 212 may store relevant payment account transaction data generated in two or more payment account systems.

Although the benefit system computer 202, the proof-of-life subsystem 208 and the payment disbursement subsystem 210 are depicted in FIG. 2 as separate functional blocks, it may be the case in some embodiments that two or more of those functional blocks are operated together in a single computer or integrated system of computers.

In some embodiments, the transaction history server computer 212 and/or the biometric system 214 may aid a number of different benefit payment organizations in confirming proof-of-life for benefit recipients of the various organizations.

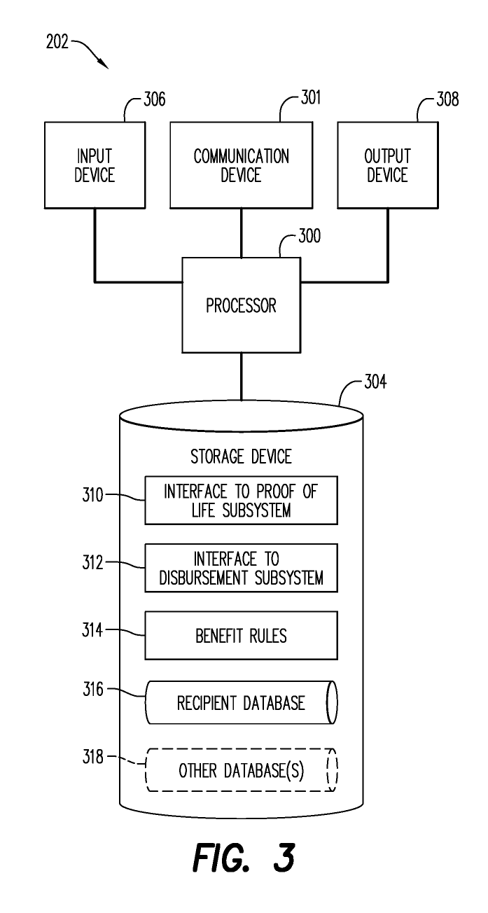

FIG. 3 is a block diagram representation of an embodiment of the benefit system computer 202.

In some embodiments, hardware aspects of the benefit system computer 202 may be constituted by typical server computer hardware and/or mainframe computer hardware, but may be controlled by software to cause the benefit system computer 202 to function as described herein.

The benefit system computer 202 may include a processor 300 operatively coupled to a communication device 301, a storage device 304, an input device 306 and an output device 308. The communication device 301, the storage device 304, the input device 306 and the output device 308 may all be in communication with the processor 300.

The processor 300 may be constituted by one or more processors. The processor 300 may operate to execute processor-executable steps, contained in program instructions described below, so as to control the benefit system computer 202 to provide desired functionality.

Communication device 301 may be used to facilitate communication with, for example, other devices (such as the proof-of-life subsystem 208 and/or the payment disbursement subsystem 210). In addition, the benefit system computer 202 may host a website to provide access or interaction with respect to recipients in the benefit payment system 200.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the benefit system computer 202, executed by the processor 300 to cause the benefit system computer 202 to function as described herein.

The programs may include one or more conventional operating systems (not shown) that control the processor 300 so as to manage and coordinate activities and sharing of resources in the benefit system computer 202, and to serve as a host for application programs (described below) that run on the benefit system computer 202.

The programs stored in the storage device 304 may also include a software interface 310 that controls the processor 300 to support communication between the benefit system computer 202 and the proof-of-life subsystem 208.

Further, the storage device 304 may store a software interface 312 that controls the processor 300 to support communication between the benefit system computer 202 and the payment disbursement subsystem 210.

Still further, the storage device 304 may store a benefit rules application program 314. The benefit rules application program 314 may control the processor 330 to cause the benefit system computer 202 to properly track and administer the benefit entitlements of the recipients under the benefit payment system 200. Supervision, oversight and direction of the proof-of-life subsystem 208 and the payment disbursement subsystem 210 may be part of the functionality provided by the benefit rules application program 314. Some details of operation of the benefit rules application program 314 will be described below.

The storage device 304 may also store, and the benefit system computer 202 may also execute, other programs, which are not shown. For example, such programs may include a reporting application, which may respond to requests from system administrators for reports on the activities performed by the benefit system computer 202. The other programs may also include, e.g., device drivers, database management programs, communications software, etc.

The storage device 304 may also store a recipient database 316 that stores personal and benefit entitlement data with respect to the benefit recipients. The recipient database 316 may be referenced by the benefit rules application program 314 for the purpose of determining when benefit payments are due to recipients, and in what amounts.

In some embodiments, the storage device 304 may also store one or more additional databases (reference numeral 318) required for operation of the benefit system computer 202.

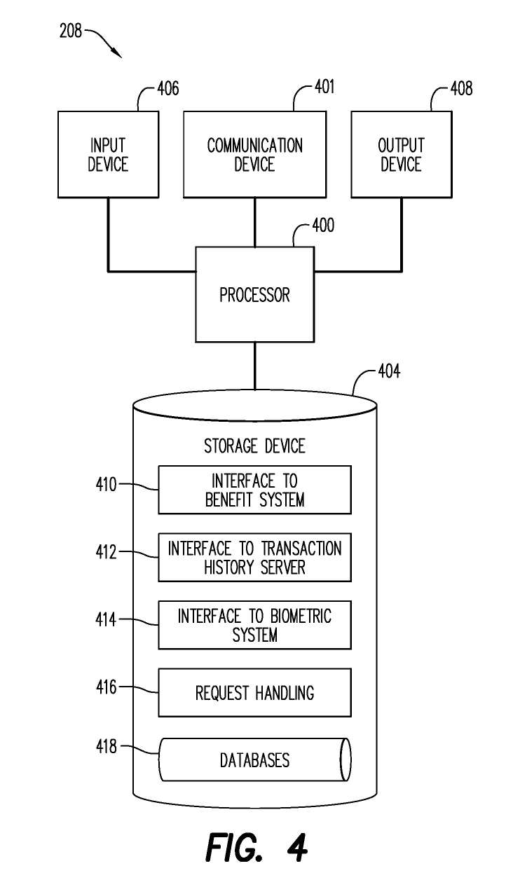

FIG. 4 is a block diagram of an embodiment of the proof-of-life subsystem 208.

In its hardware architecture and components, the proof-of-life subsystem 208 may, for example, resemble the hardware architecture and components described above in connection with FIG. 3. However, the proof-of-life subsystem 208 may be programmed differently from the benefit system computer 202 so as to provide different functionality.

Returning again to the hardware aspects of the proof-of-life subsystem 208, it may include a processor 400, a communication device 401, a storage device 404, an input device 406 and an output device 408. The communication device 401, the storage device 404, the input device 406 and the output device 408 may all be in communication with the processor 400.

The above descriptions of the hardware components shown in FIG. 3 may, in some embodiments, also be applicable to the like-named components shown in FIG. 4.

Storage device 404 stores one or more programs for controlling processor 400. The programs comprise program instructions (which may be referred to as computer readable program code means) that contain processor-executable process steps of the proof-of-life subsystem 208, executed by the processor 400 to cause the proof-of-life subsystem 208 to function as described herein.

The programs may include one or more conventional operating systems (not shown) that control the processor 400 so as to manage and coordinate activities and sharing of resources in the proof-of-life subsystem 208, and to serve as a host for application programs (described below) that run on the proof-of-life subsystem 208.

The programs stored in the storage device 404 may include a software interface 410 that controls the processor 400 to support interactions between the proof-of-life subsystem 208 and the benefit system computer 202. The storage device 404 may also store a software interface 412 that controls the processor 400 to support interactions between the proof-of-life subsystem 208 and the transaction history server computer 212. Still further, the storage device 404 may store a software interface 414 that controls the processor 400 to support interactions between the proof-of-life subsystem 208 and the biometric system 214.

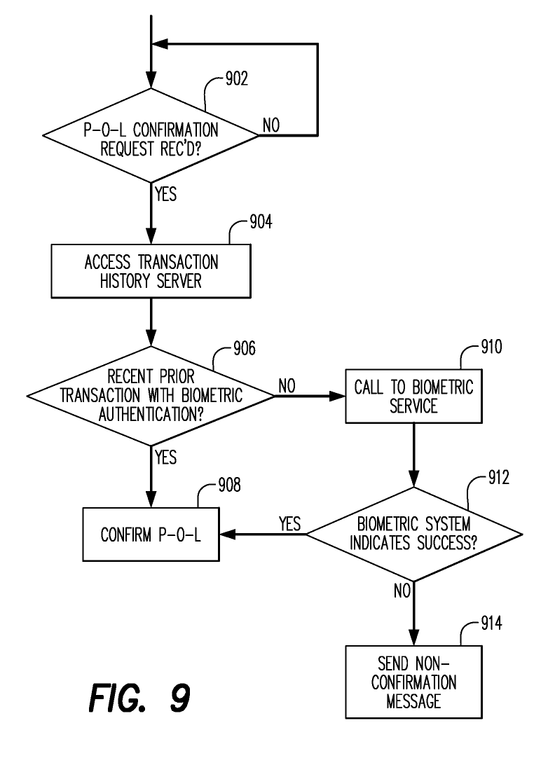

Further, the storage device 404 may store a request handling program 416 that handles requests from the benefit system computer 202 that the proof-of-life subsystem 208 attempt to confirm proof-of-life with respect to various benefit recipients. Details of the functionality provided by the request handling program 416 will be described below, including with reference to FIG. 9.

Continuing to refer to FIG. 4, the storage device 404 may also store, and the proof-of-life subsystem 208 may also execute, other programs, which are not shown. For example, such programs may include a reporting application, which may respond to requests from system administrators for reports on the activities performed by the proof-of-life subsystem 208. The other programs may also include, e.g., device drivers, database management programs, communication software, etc.

The storage device 404 may also store one or more databases 418 that may be required for operation of the proof-of-life subsystem 208.

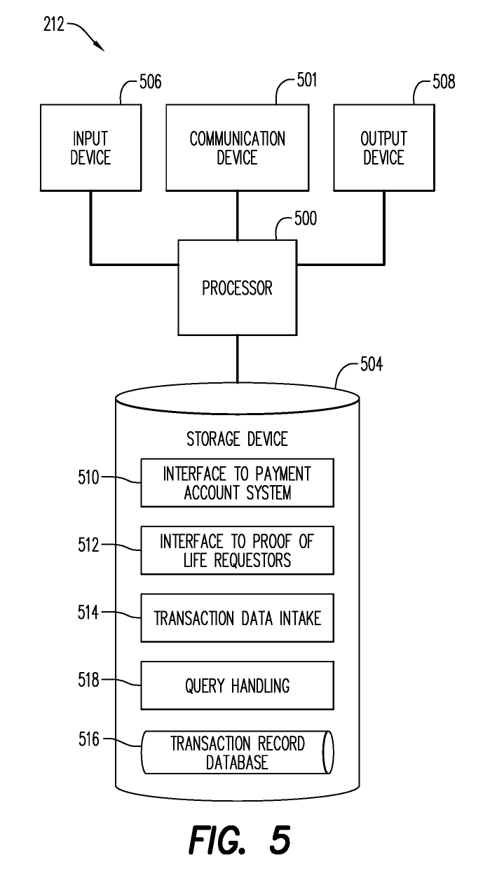

FIG. 5 is a block diagram of an embodiment of the transaction history server computer 212.

In its hardware architecture and components, the transaction history server computer 212 may, for example, resemble the hardware architecture and components described above in connection with FIG. 3. However, the transaction history server computer 212 may be programmed differently from the benefit system computer 202 and the proof-of-life subsystem 208 so as to provide different functionality.

It will also be recalled that the transaction history server computer 212 may be operated by a different entity from the benefit system computer 202, the proof-of-life subsystem 208 and the payment disbursement subsystem 210.

Returning again to the hardware aspects of the transaction history server computer 212, it may include a processor 500, a communication device 501, a storage device 504, an input device 506 and an output device 508. The communication device 501, the storage device 504, the input device 506 and the output device 508 may all be in communication with the processor 500.

The above descriptions of the hardware components shown in FIG. 3 may, in some embodiments, also be applicable to the like-named components shown in FIG. 5.

Storage device 504 stores one or more programs for controlling processor 500. The programs comprise program instructions (which may be referred to as computer readable program code means) that contain processor-executable process steps of the transaction history server computer 212, executed by the processor 500 to cause the transaction history server computer 212 to function as described herein.

The programs may include one or more conventional operating systems (not shown) that control the processor 500 so as to manage and coordinate activities and sharing of resources in the transaction history server computer 212, and to serve as a host for application programs (described below) that run on the transaction history server computer 212.

The programs stored in the storage device 504 may include a software interface 510 that controls the processor 500 to support interactions between the transaction history server computer 212 and the payment account system 100a (and in particular, perhaps, a suitably modified embodiment of the payment network 110 shown in FIG. 1).

Continuing to refer to FIG. 5, the storage device 504 may further store a software interface 512 that controls the processor 500 to support interactions between the transaction history server computer 212 and the proof-of-life subsystem 208.

In addition, the storage device 504 may store a transaction data intake program 514. The transaction data intake program may control the processor 500 to enable the transaction history server computer 212 to receive transaction data from the payment system 100a and to store the transaction data in a transaction record database 516. The transaction record database 516 may also be stored in the storage device 504.

Depending on the functionality desired or expected of the transaction history server computer 212, the transaction history server computer 212 may only receive and store transaction records for payment account transactions that included a successful biometric-based user authentication. In some embodiments, again depending on the functionality desired or expected, the transaction records may be purged from the transaction record database 516 after passage of a certain amount of time after the date and time of the transaction. For example, the transaction records may be purged after they become “stale” in the sense that the records would no longer be deemed useful for a current proof-of-life or for any other purpose that may be applicable for the records. Each record may, for example, contain a positive indication that the transaction included biometric-based user authentication. Alternatively, the process by which the records are taken into the transaction record database may itself assure that every record in the database represents a transaction that included biometric-based user authentication. Accordingly, in the latter type of arrangement, the presence of the transaction record in the transaction record database 516 is itself an indication that biometric user authentication occurred in connection with the corresponding payment account system transaction.

Continuing to refer to FIG. 5, the storage device 504 may also store a query handling application program 518. The query handling application program 518 may control the processor 500 such that the transaction history server computer 212 is enabled to handle queries from the proof-of-life subsystem 208 for confirmation of proof-of-life of benefit recipients. Details of such queries and the possible results that are returned are described below.

The storage device 504 may also store, and the transaction history server computer 212 may also execute, other programs, which are not shown. For example, such programs may include a reporting application, which may respond to requests from system administrators for reports on the activities performed by the transaction history server computer 212. The other programs may also include, e.g., device drivers, database management programs, communication software, etc.

Other computer components of the benefit payment system 200 (FIG. 2) may also have the same type of hardware architecture and/or components as described above in connection with FIG. 3, and may be suitably programmed for the respective roles of those computer components.

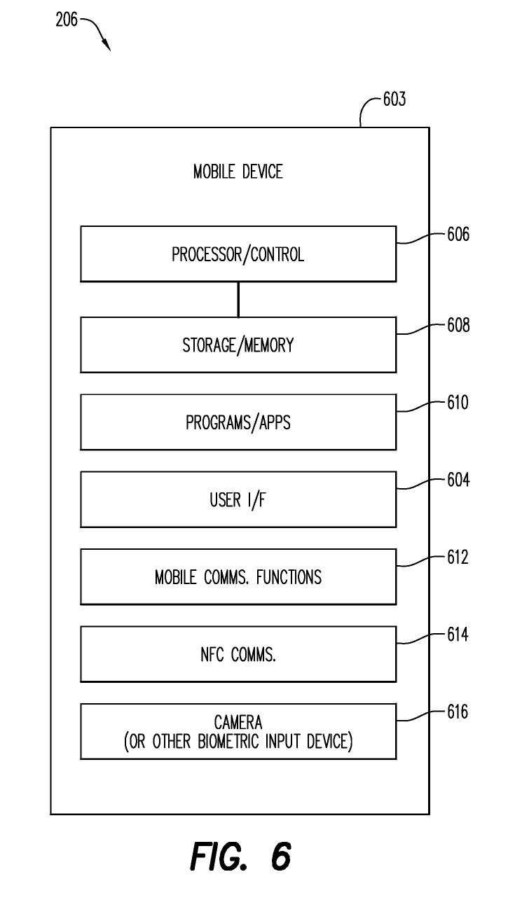

FIG. 6 is a block diagram that shows some features of a typical embodiment of the mobile device 206 shown in FIG. 2.

Continuing to refer to FIG. 6, the mobile device 206 may include a housing 603. In many embodiments, the front of the housing 603 is predominantly constituted by a touchscreen (not separately shown), which is a key element of the user interface 604 of the mobile device 206.

The mobile device 206 further includes a mobile processor/control circuit 606, which is contained within the housing 603. Also included in the mobile device 206 is a storage/memory device or devices (reference numeral 608). The storage/memory devices 608 are in communication with the processor/control circuit 606 and may contain program instructions to control the processor/control circuit 606 to manage and perform various functions of the mobile device 206. As is well-known, a device such as mobile device 206 may function as what is in effect a pocket-sized personal computer (assuming for example that the mobile device is a smartphone), via programming with a number of application programs, or “apps”, as well as a mobile operating system (OS). (The apps are represented at block 610 in FIG. 6, and may, along with other programs, in practice be stored in block 608, to program the processor/control circuit 606.) As is typical for mobile devices, the mobile device 206 may include mobile communications functions as represented by block 612. The mobile communications functions 612 may include voice and data communications via a mobile communication network with which the mobile device 206 is registered.

In addition, the mobile device 206 may have hardware and software features that allow the mobile device 206 to be used as a contactless payment device. Accordingly, the mobile device 206 may include short-range radio communications capabilities (block 614), including for example NFC and/or Bluetooth.

Also, like a typical smartphone, the mobile device 206 may include a camera 616. The camera 616 may operate to capture images of the user's face for purposes of allowing the mobile device (or a remote device) to perform facial recognition processing. In addition or alternatively, the mobile device 206 may include a fingerprint sensor (also represented by block 616) or another component of the mobile device 206 by which a biometric measure may be taken from the user of the mobile device 206.

From the foregoing discussion, it will be appreciated that the blocks depicted in FIG. 6 as components of the mobile device 206 may in effect overlap with each other, and/or there may be functional connections among the blocks which are not explicitly shown in the drawing. It may also be assumed that, like a typical smartphone, the mobile device 206 may include a rechargeable battery (not shown) that is contained within the housing 603 and that provides electrical power to the active components of the mobile device 206.

It has been posited that the mobile device 206 may be embodied as a smartphone, but this assumption is not intended to be limiting, as mobile device 206 may alternatively, in at least some cases, be constituted by a tablet computer or by other types of mobile computing devices.

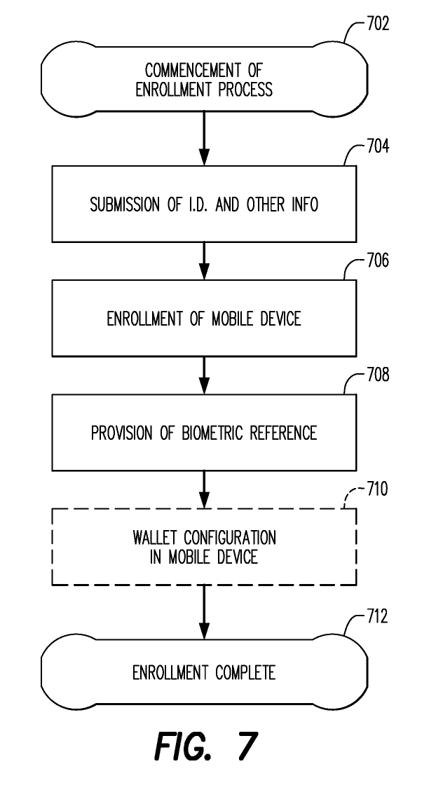

FIG. 7 is a flow chart that illustrates aspects of the present disclosure. In particular, FIG. 7 illustrates a process that may be performed in connection with enrollment of a recipient with the benefit payment system 200.

Block 702 in FIG. 7 indicates commencement of the enrollment process.

At block 704, the recipient may present appropriate documentation to establish the recipient's identity and/or other documentation, including documentation that establishes the recipient's entitlement to begin receiving benefit payments. In some embodiments, the process at block 704 may involve one or more visits by the recipient to offices of the benefit payment system 200. In some embodiments, the recipient may also select a manner in which the benefit payments are to be made, including for example, identification of a bank account to which electronic transfers are to be made, or a mailing address to which checks or pre-paid payment cards are to be sent.

At block 706, the recipient may enroll his/her mobile device with the benefit payment system 200. This may involve providing data concerning the mobile device such as the mobile telephone number assigned to the mobile device and/or one or more other items of identifying data with respect to the mobile device.

At block 708, the recipient may provide biometric reference data to the benefit payment system. For example, if voice recognition is to be used for biometric proof-of-life authentication, the recipient may provide one or more voice samples. If fingerprint recognition is to be used for biometric proof-of-life authentication, the recipient may present one of his/her finger tips for scanning. If facial recognition is to be used for biometric proof-of-life authentication, the user may provide an image of his/her face or allow an image of his/her face to be taken. Other types of biometric identity verification are known and may be used in addition to or instead of those listed above. The biometric reference data resulting from the recipient's submission to a biometric measure may be stored in a recipient database in, e.g., the biometric system 214 (FIG. 2).

Continuing to refer to FIG. 7, in some embodiments and/or in some situations, and as indicated by block 710, the recipient may arrange to have his/her mobile device configured with a wallet application (“app”) to permit the recipient to access the benefit funds via the mobile device.

Block 712 in FIG. 7 indicates completion of the recipient enrollment process.

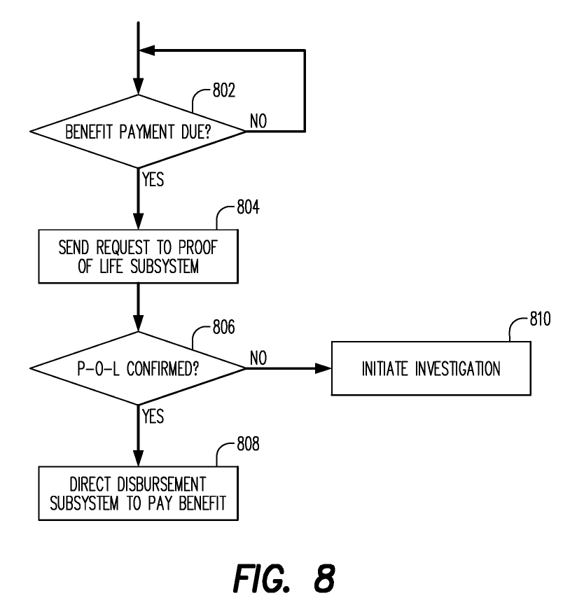

FIG. 8 is a flow chart that illustrates aspects of the present disclosure. In particular, FIG. 8 illustrates a process that may be performed in and/or by the benefit system computer 202.

At decision block 802 in FIG. 8, the benefit system computer 202 determines whether a benefit payment is due to be made to a given recipient. If so, then block 804 may follow decision block 802 in the process of FIG. 8. At block 804, the benefit system computer 202 may send a request to the proof-of-life subsystem 208 to confirm proof-of-life with respect to the recipient in question. The request may identify the recipient.

At this point further discussion of FIG. 8 will be deferred, and attention will be directed to a discussion of FIG. 9.

FIG. 9 is a flow chart that illustrates aspects of the present invention. In particular, FIG. 9 illustrates a process that may be performed in and/or by the proof-of-life subsystem 208. As will be seen, the process of FIG. 9 may be triggered by a request from the benefit system computer 202 as mentioned in connection with block 804 in FIG. 8.

Referring, then, to FIG. 9, at decision block 902, the proof-of-life subsystem 208 may determine whether it has received a request from the benefit system computer 202 to confirm proof-of-life with respect to a given recipient. If so, then block 904 may follow decision block 902 in the process of FIG. 9.

At block 904, the proof-of-life subsystem 208 may access the transaction history server computer 212 (FIG. 2). This may involve the proof-of-life subsystem 208 sending a request for data and/or a database query to the transaction history server computer 212. For example, the request for data may request the date and time of the most recent payment account system transaction in which the recipient successfully provided biometric-based user authentication, as recorded by the transaction history server computer 212.

It may be assumed for purposes of FIG. 9 that the transaction history server provides a response to the request made by the proof-of-life subsystem 208. In some cases it may be a null response, i.e., an indication that no record is available. In other cases, the transaction history server computer 212 may respond to the proof-of-life subsystem 208 by providing a date and time of the most recent payment system account transaction of the recipient in which biometric user authentication was successful. In some embodiments, the transaction history server computer 212 may also provide further information concerning the most recent transaction of that kind. In some embodiments, the transaction history server computer 212 may provide data about more than one payment system account transaction engaged in by the recipient.

At decision block 906, the proof-of-life subsystem 208 may determine, based on the response from the transaction history server computer 212, whether there has been a recent payment account system transaction by the recipient including biometric authentication of the recipient. In making this determination, the proof-of-life subsystem 208 may be guided by a rule that indicates how recent a transaction must be in order to be deemed a satisfactory indication of proof-of-life for the recipient. For example, in some embodiments, a transaction with biometric user authentication may be deemed sufficiently recent only if it has occurred within the past 24 hours. In other embodiments, the time period used to judge whether or not the transaction is “recent” may be a number of days or a week (i.e., seven days). Other time limits are possible. The time limit may be referred to as a “pre-determined permissive time interval”. In making the determination at 906, the proof-of-life subsystem 208 may measure the lapse of time since the transaction against the pre-determined permissive time interval. That lapse of time may be viewed as a time interval defined by two points in time, namely the point in time when the payment account system transaction occurred and the point in time when the proof-of-life subsystem 208 accessed the transaction history server computer 212. If the latter time interval does not exceed the pre-determined permissive time interval, then the proof-of-life subsystem 208 may make a positive determination at decision block 906. If the latter time interval exceeds the pre-determined permissive time interval, then the proof-of-life subsystem 208 may make a negative determination at decision block 906. Moreover, if the transaction history server computer provides a null response or in some other way fails to report an appropriate payment account system transaction with biometric user authentication for the recipient, then the proof-of-life subsystem 208 may make a negative determination at decision block 906.

If the proof-of-life subsystem 208 makes a positive determination at decision block 906, then block 908 in FIG. 9 may follow decision block 906. At block 908, the proof-of-life subsystem 208 may send a message to the benefit system computer 202 to indicate confirmation of proof-of-life for the recipient in question.

If the proof-of-life subsystem 208 makes a negative determination at decision block 906, then block 910 may follow decision block 906 in FIG. 9. At block 910, the proof-of-life subsystem 208 may call on the biometric system 214 to attempt to confirm proof-of-life with respect to the recipient in question. For purposes of FIG. 9, it may be assumed that the biometric system 214 responds by issuing a biometric challenge to the recipient 204 (FIG. 2) via, e.g., the recipient's mobile device 206. In some embodiments, the biometric system 214 may issue the biometric challenge in one or more of the ways in which payment systems have issued, or have been proposed to issue, such challenges. To give just one example, if the mobile device is of the kind that includes a fingerprint sensor, then the challenge may direct the recipient present his/her fingertip to the fingerprint sensor. Such a challenge and the response thereto may be managed via a secure app in the mobile device. Other types of biometric challenge and response may alternatively be employed, including techniques of biometric user authentication that are proposed in the future.

At decision block 912 in FIG. 9, the proof-of-life subsystem 208 may determine whether the biometric system 214 has indicated successful completion of the biometric authentication of the recipient as requested at 910. If so, then block 908, as described above, may follow decision block 912 in FIG. 9. However, if the proof-of-life subsystem 208 makes a negative determination at decision block 912 (i.e., if the biometric system did not indicate successful completion of the biometric authentication of the recipient), then block 914 may follow decision block 912 in FIG. 9.

At block 914, the proof-of-life subsystem 208 may send a message to the benefit system computer 202 to indicate that proof-of-life cannot be confirmed for the recipient in question.

Thus the process of FIG. 9 ends either in confirmation or non-confirmation of proof-of-life for the recipient by the proof-of-life subsystem 208.

At this point, the discussion will return to the process of FIG. 8. In decision block 806 in FIG. 8, the benefit system computer 202 may determine whether or not the proof-of-life subsystem 208 has indicated confirmation of proof-of-life for the recipient. If so, then block 808 may follow decision block 806 in FIG. 8. At block 808, the benefit system computer 202 may direct the payment disbursement subsystem 210 to make the benefit payment currently due to the recipient. This may occur by the established mechanism for the recipient's benefit payment, e.g., as established at block 704 in FIG. 7.

If the benefit system computer 202 makes a negative determination at decision block 806 (FIG. 8), then block 810 may follow decision block 806. At block 810, the benefit system computer 202 may initiate an investigation or take other suitable steps in view of the inability to currently confirm proof-of-life with respect to the recipient. For example, personnel of the benefit payment system 200 may inquire as to whether the recipient has died, or whether there is some other reason (e.g., an injury or illness suffered by the recipient, a separation of the recipient from his/her mobile device, the recipient's absence from his/her country of residence, etc.) why proof-of-life cannot be confirmed. In some embodiments, a message or mailing may be sent to the recipient summoning the recipient to visit the offices of the benefit payment system 200.

It is to be noted that if the process of FIG. 8 branches from decision block 806 to block 810, the benefit payment that is due may be at least deferred and possibly may not be made at all.

With a proof-of-life technique as described herein, making use of payment account system transaction records, benefit payment systems can verify a recipient's continued eligibility in a highly cost-effective, convenient and non-intrusive manner. As an adjunct to a biometric-based proof-of-life system, the initial reference to payment account system transaction data may reduce the burdens involved in serving the benefit payment system by the biometric-based system, and may allow for fewer resources to be needed for the latter. In effect, the benefit payment system may piggy-back on and partially rely on biometric transaction-user authentication systems deployed or to be deployed by payment account systems, payment account issuers, mobile device manufacturers and associated entities.

In some embodiments, the biometric proof-of-life system 214 may be omitted, and the proof-of-life confirmation via payment account system transaction data may be used without a separate biometric system backup. In such embodiments, if proof-of-life is not confirmed from payment account system transaction data, then further steps such as summoning the recipient for an office visit, and/or inquiries by benefit payment system personnel, etc., may be undertaken.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of steps.

As used herein and in the appended claims, the terms “payment transaction” and “payment account system transaction” are to be considered equivalent to each other.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the terms “payment account system” and “payment card system” are used interchangeably and refer to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
determining that a benefit payment is due to be made to a recipient;
accessing a data store containing records of payment transactions made by the recipient;
receiving an indication from the data store that the recipient had successfully performed a biometric user authentication with respect to at least one of the payment transactions;
accepting the received indication as proof-of-life with respect to the recipient; and
making the benefit payment to the recipient in response to said proof-of-life.

2. The method of claim 1, wherein said at least one payment transaction occurred during a pre-determined period of time prior to said accessing step.

3. The method of claim 2, wherein said pre-determined period of time is seven days.

4. The method of claim 2, wherein said pre-determined period of time is 24 hours.

5. The method of claim 1, wherein the benefit payment is a social insurance transfer payment.

6. The method of claim 1, wherein the at least one of the payment transactions includes a credit card account transaction and/or a debit card account transaction.

7. The method of claim 6, wherein a mobile device was used by the recipient to initiate the at least one payment transaction.

8. The method of claim 1, wherein the benefit payment is made via an electronic monetary transfer to an account owned by the recipient.

9. The method of claim 1, wherein the benefit payment is made by sending a check to the recipient.

10. A method comprising:
determining that a benefit payment is due to be made to a recipient;
accessing, at a first point in time, a data store containing records of payment transactions made by the recipient;
determining that the data store contains an indication that the recipient had successfully performed a biometric user authentication most recently with respect to one of said payment transactions at a second point in time earlier than the first point in time;
comparing a time interval defined by the second and first points in time with a pre-determined permissive time interval;
making the benefit payment, without requiring proof-of-life authentication of the recipient, in a case where the time interval defined by the second and first points in time does not exceed the pre-determined permissive time interval; and
requiring proof-of-life authentication of the recipient, prior to making the benefit payment, in a case where the time interval defined by the second and first points in time exceeds the pre-determined permissive time interval.

11. The method of claim 10, wherein the pre-determined permissive time interval is seven days.

12. The method of claim 10, wherein the pre-determined permissive time interval is 24 hours.

13. The method of claim 10, wherein the benefit payment is a social insurance transfer payment.

14. An apparatus comprising:
a processor; and
a memory in communication with the processor, the memory storing program instructions, the processor operative with the program instructions to perform functions as follows:
determining that a benefit payment is due to be made to a recipient;
accessing a data store containing records of payment transactions made by the recipient;
receiving an indication from the data store that the recipient had successfully performed a biometric user authentication with respect to at least one of the payment transactions;
accepting the received indication as proof-of-life with respect to the recipient; and
making the benefit payment to the recipient in response to said proof-of-life.

15. The apparatus of claim 14, wherein said at least one payment transaction occurred during a pre-determined period of time prior to said accessing.

16. The apparatus of claim 15, wherein said pre-determined period of time is seven days.

17. The apparatus of claim 15, wherein said pre-determined period of time is 24 hours.

18. The apparatus of claim 14, wherein the benefit payment is a social insurance transfer payment.

19. The apparatus of claim 14, wherein the at least one of the payment transactions includes a credit card account transaction and/or a debit card account transaction.

20. The apparatus of claim 19, wherein a mobile device was used by the recipient to initiate the at least one payment transaction.
